(19) United States
(12) Patent Application Publication
(10) Pub. No.: US 2025/0224258 A1
(43) Pub. Date: Jul. 10, 2025

(54) PHYSICAL QUANTITY MEASUREMENT SYSTEM AND/OR FOR POSITION MEASUREMENT WITH BISTABLE MAGNETIC WIRE, METHOD OF MEASUREMENT

(71) Applicant: RVmagnetics, a.s., Košice (SK)

(72) Inventor: Rastislav VARGA, Hodkovce (SK)

(21) Appl. No.: 18/854,006

(22) PCT Filed: Mar. 30, 2023
(86) PCT No.: PCT/IB2023/053187

§ 371 Date: Oct. 3, 2024

(30) Foreign Application Priority Data
Apr. 6, 2022 (EP) 22166892.4

(51) Int. Cl. G01D 5/20

(52) U.S. Cl. CPC G01D 5/20

(57) ABSTRACT

The system for physical quantity measurement and/or for position measurement with a bistable magnetic wire (1), which comprises excitation element (2) for creating of magnetic field and a sensing element (3). Within the range of the magnetic field of the excitation element (2), a bistable magnetic wire (1) is placed, which has a first end (11) and an oppositely placed second end (12). The bistable magnetic wire (1) is adjusted for magnetization by a single Barkhausen jump from the first end (11) to the second end (12) or vice versa, wherein the excitation element (2) and bistable magnetic wire (1) are placed in a mutual position with an asymmetric magnetic field with respect to the bistable magnetic wire (1), where the size of the magnetic field excited by the excitation element (2) at the first end (11) is different from the size of the magnetic field excited by the excitation element (2) at the second end (12). The asymmetry of the magnetic field is created due to the mutual asymmetrical position of the excitation element (2) and the bistable magnetic wire (1) and/or due to the asymmetrical construction of the excitation element (2).

### TECHNICAL FIELD

The invention relates to a composition of excitation element and a bistable magnetic wire, where a composition is prepared for measuring of various physical quantities and/or for position measurement of the bistable magnetic wire. The novelty of the system and method lies mainly in the specific asymmetrical position of a magnetic field of the excitation element and the actually bistable magnetic wire, thanks to which the interpretive value of the raw measured data is significantly improved.

### BACKGROUND ART

The bistable magnetic elements are used for measurement various physical quantities and position, where the bistable magnetic element is formed by a passive member which by its magnetization reacts to a change in position in the magnetic field or to a change in a physical quantity.

An alloy with bistable magnetic properties and a micro wire from this alloy is described, for example, in document GB2374084A. The micro wire is able to respond to various physical quantities, but response evaluation is problematic, because prior art bistable magnetic elements can have complex magnetic acts where the magnetization occurs in a multiple domains within a single micro wire, not a single wall jump. Applications of bistable magnetic wires in position measurement, angular measurement and revolution measurement are also known.

The excitation of a bistable magnetic wire that is wound up on a core, is clarified in document U.S. Pat. No. 4,484,090A. The solution does not allow to evaluate physical quantities. Some magnetic acts of a bistable magnetic element are described in document JPH03252577A, which, however does not solve the problems with the interpretation of the measured nonlinear values.

DE2817169A1, DE3427582A1, SU1753425A1 describe systems with a Wiegand wire having a certain level of magnetic bistability, wherein these systems serve to determine the approximation of a bistable magnetic element to a sensor. Due to this arrangement, it is not possible for measurement the values of physical quantities in the vicinity of the bistable magnetic element.

The position sensor or rotation sensor according to publication EP0484716A1 uses the Wiegand wire to which rotating permanent magnets approach. The sensor responds only to changes of the magnetic field, it does not evaluate the size of physical quantities.

The Wiegand sensor according to document DE4107847C1 allows to contactlessly transfer the information about closure of the switch, which can react to the change in a physical quantity such as temperature, pressure, acceleration, but it requires an appropriate sensor by which subsequently the switch is controlled, i. e. the physical quantity is not measured by the bistable magnetic element itself.

A new technical solution is desired and not known which with simple construction, will improve the repeatable interpretability of the measurement of various physical quantities, wherein eliminating noise and the influence of secondary phenomena. The bistable magnetic element itself has to react to the changes in the measured physical quantity and also generate a response, which is contactlessly transmitted to the receiving element.

### NATURE OF INVENTION

Said shortcomings are substantially eliminated by a system for measuring a physical quantity and/or for position measurement with bistable magnetic wire, where the system comprises the excitation element for generating a magnetic field within range of which the bistable magnetic wire is placed. The bistable magnetic wire has a first end and an oppositely placed second end, therefore is not wound into a screw or coil, wherein the bistable magnetic wire is adjusted for magnetization by a single Barkhausen front jump from the first end to the second end or vice versa, according to this invention, the nature of which consists in that the excitation element and the bistable magnetic wire are placed in a mutual position in which the size of the magnetic field excited by the excitation element at the first end is different from the size of the magnetic field excited by the excitation element at the second end. The magnetic field at the first end and at the second end is different in every moment of the non-zero excitation, thus at a given moment, wherein the excitation is dynamic in time. The system also comprises a receiving element for response receiving from the bistable magnetic wire.

The terms first and second in this document are used to name two ends differently, and these are interchangeable, thus the terms first and second does not express the superiority or importance of the respective end of the bistable magnetic wire.

The different magnetic field at the ends in given moment of excitation leads to an asymmetric magnetic field, which, together with magnetization by a single Barkhausen jump, leads to repeatable interpretable measurement results. For practical measuring applications, it is important that the behavior of the bistable magnetic wire is influenced fundamentally by the measured quantity or measured position, and that other factors, including acts of more complex magnetic properties of the bistable magnetic wire, were negligible or at least identifiable in a way that allows correction when evaluating raw data.

To ensure the asymmetry of the mutual position of the excitation field and the bistable magnetic wire, a difference of 5%, preferably 10%, especially preferably more than 25% in the values of the magnetic field at the first end and at the second end is sufficient. This contributes to the magnetization taking place in one jump within the entire wire from one end to the other. If the magnetization took place within a number of separate domains along the length of the wire, the measured response would include a number of individual acts, which significantly impairs the interpretability of the measurement. It is not possible to subsequently identify the dependence of the measured data, which reduces the application possibilities of the bistable magnetic wire. The aim of this invention is to achieve effective, thus complete, real bistability of magnetization, where the domain structure of the bistable magnetic wire does not consist of many domains, which would otherwise lead to magnetization by movement of multiple domains within a single wire. The measurement of a bistable magnetic wire with multiple domains along its length can be compared to the measurement of several separate bistable magnetic wires in a single excitation field, what causes that the resulting measurement is a sum of individual responses that cannot be reliably identified and the summary response vector is therefore practically unusable.

Several technical possibilities can be used to create relatively asymmetrical magnetic field, wherein the appropriate choice of the respective construction will also depend on the specific measured quantity or position. In principle, by system according to this invention the temperature, pressure/tension, magnetic field can be measured. From these basic quantities, a whole range of other physical quantities as well as various positional relationships can be measured indirectly, the presence of bistable magnetic wires can be measured, their mutual position, electric current parameters can be measured by measuring the magnetic field at the conductor, position and linear feed in the earth's magnetic field or bending and torsional stress or flow of liquid or gas based on the measurement of elongation in the respective direction can be measured.

The measurement of changes in the magnetic field allows to detect a change in position, a change in the rotation of the bistable magnetic wire or the carrier on which the bistable magnetic wire is mounted, and also allows to measure the relative position with respect to another object carrying the excitation element. On this basis, it is possible to construct position sensors, rotation sensors, end sensors, sensors of proximity of a magnetic object or carrier with a magnetic object, sensors of absolute position with respect to earth's magnetic field, and the like.

The antenna of the excitation element may be used for measurement the response, or preferably the system comprises a separate receiving element, for example in the form of a receiving coil. In this case, the excitation element may be a primary coil, and the receiving element will be formed by a secondary coil. The secondary coil can be connected to an amplifier and an evaluation unit. The receiving element may be located coaxially with the position of the bistable magnetic wire or may be in another position mutual to each other so as to be within range to allow for response to be received.

It is suitable embodiment where the bistable magnetic wire is in the form of a micro wire with a diameter less than 50 μm, preferably less than 25 μm, especially preferably less than 15 μm. It is precisely at core diameters less than 15 μm and with suitable composition of the amorphous metal alloy, the radial magnetic structure disappears, which is related to the process of wire drawing with simultaneous rapid cooling, usually water cooling. Thanks to that the bistable magnetic wire behaves as fully bistable, thus effectively bistable over the entire length of the wire, and the domain wall during magnetization runs from the first end to the second end, not separately within several individual zones along the length of the wire. It has also been found suitable if the length of the bistable magnetic wire is at least 100 times, preferably at least 10000 times larger than the diameter of the bistable magnetic wire, which implies that it will be a small diameter wire, which we can also call micro wire.

A typical construction of the bistable magnetic wire includes an amorphous metal core and a cover, for example glass cover, whose outer diameter is no larger than three times the diameter of the metal core. The thickness of the glass cover can range 1 to 20 μm. The glass cover, glass surface layer, protects the metal core from electrical contact with the environment, from aggressive chemical environment, thanks to which the bistable magnetic wire can be used very universally, for example directly in the electric motor windings or inside of building materials, inside of human body and the like. In principle, it is also possible to use a bistable magnetic wire without a circumferential cover, or it is also possible to use the cover of a different material than glass.

A magnetic excitation with a triangular signal, usually with a symmetrical triangular signal, which simplifies the evaluation of measured signal as described in older publications of the authors of this invention, has proven to be suitable. With this aim, the system according to this invention is adjusted to be connected to a power element, a control element and an evaluation element. According to the instruction from the control element, the power element transmits to the excitation element a power supply regulated to obtain a triangular excitation signal. The evaluation element acquires and analyzes the response received from the bistable magnetic wire.

The asymmetry of the excitation field can be achieved in such a way that the excitation element, which induces a substantially symmetrical field, is arranged relatively asymmetrically with respect to the bistable magnetic wire. As shown in FIG. 3, positional asymmetry ensures that the first end of the bistable magnetic wire is in a higher magnetic field than the second end, and therefore the bistable magnetic wire will be magnetized always with movement of one domain wall, the one which is in the higher field. Positional asymmetry can be achieved by setting a spatial relationship. At the same time, the coil of the excitation element and the bistable magnetic wire can be arranged coaxially, thus with identical or parallel-oriented longitudinal axes.

The asymmetry of the excitated magnetic field can be ensured by the construction of the excitation element with an uneven coil winding, for example with different thread pitches or with different number of threads at the first end or at the second end. The result of such a construction of the excitation element is a different size of the magnetic field at the ends of the excitation element, or at a certain distance from these ends. In such a case, the mutual position of the excitation element and the bistable magnetic wire may be spatially symmetrical, but at the first end and at the second end of the bistable magnetic wire, it will be in a differently sized magnetic field.

The definition describing the mutual position of the excitation element and the bistable magnetic wire according to the first claim also includes a symmetrical mutual position if an asymmetrical magnetic field is generated by the excitation element. The definition of the first claim expresses a mutual arrangement, which can be achieved by several means, or by a different combination of technical means and relative spatial arrangement. The asymmetry of the magnetic field important to achieving the effects according to this invention is always understood in the relative relationship of the sizes of the magnetic field at the first end and at the second end. The asymmetry of the excited magnetic field can also be achieved by adding a shielding element or by placing another, secondary coil to the primary coil to the primary coil of the excitation element. In such a case, the mutual position of the excitation element and the bistable magnetic wire may also appear to be spatially symmetrical, but the asymmetry of the magnetic field at the first end and at the second end will be important.

In all versions of the asymmetry of the magnetic field, the excitation element can be placed coaxially with the position of the bistable magnetic wire or can be placed next to the bistable magnetic wire. In most applications, it is assumed that the longitudinal axis of the magnetic field generated by the excitation element will be essentially parallel to the longitudinal axis of the bistable magnetic wire, but in principle an angularly different position is also possible, for example, the longitudinal axis of the excitation element deviates from the longitudinal axis of the bistable magnetic wire within 30 degrees.

The disadvantages mentioned in the prior art are eliminated by the method for physical quantity measurement and/or for position measurement with the bistable magnetic wire, where a variable magnetic field is transmitted by the excitation element, wherein at least one bistable magnetic wire is placed within the range of the excited magnetic field, which is magnetized when the magnetic field changes by a single Barkhausen front jump from the first end to the second end or vice versa and where the response of the bistable magnetic wire is subsequently sensed by a sensing element, according to this invention, the nature of which lies is that the excitation element and the bistable magnetic wire are maintained in a mutual position, in which the size of the magnetic field excited by the excitation element at the first end is different from the size of the magnetic field excited by the excitation element at the second end. Defining the difference in the size of the magnetic field at the ends should be explained by the fact that this difference applies in the static state, when the changing position of the bistable magnetic wire is not measured, even if the bistable magnetic wire can move with respect to the excitation element (e.g. when measuring the pressure in a rotating tire). This means that at the moment of magnetization, the ends of the bistable magnetic wire are in differently sized magnetic field. In the case of measuring the changing position of the bistable magnetic wire, e. g. when measuring the linear position, again applies, that at the moment of magnetization, the ends of the bistable magnetic wire are in differently sized magnetic field, and at the same time there is a difference in the magnetic fields, due to the movement that is the subject of measurement.

At the same time, it is preferable, if the magnetic field has a triangular shape, especially preferably a symmetrical triangular shape, and the time of the local maximum and the time of the local minimum of response of the bistable magnetic wire are evaluated, which are essentially the time points of magnetization of the bistable magnetic wire. The sum of these times is a parameter that expresses the dependence of the measured quantity or position, wherein other unmeasured factors and noise are suppressed. This improves the interpretability of the measured data and also accelerates their evaluation. It is also suitable if the difference between these times is calculated and this parameter expresses the parasitic magnetic field, which interferes the measurement of conventional magnetic sensors. The process according to this invention suppresses the effects of the parasitic magnetic field.

An important feature of both the system and the method according to this invention is the fact that in the evaluation of the response signal, the local maximums and minimums are searched, and after their recognition, we work with times T1, T2, at which these maximums and minimums were measured. Furthermore, the method does not work on the basis of the values of the measured amplitudes, as was common in the prior art, but works with the values of the times, which is an easily and clearly identifiable parameter in the received signals. Thanks to that evaluation fast, accurate and insensitive to various secondary effects. For example, the exact position, shape and size of the excitation and sensing elements are not important.

In the development of the subject of the invention, it has been shown that a bistable magnetic wire has a different reactivity per measured quantity according to the frequency of the excitation field. In a preferable arrangement, therefore, the method according to this invention comprises the step of exciting the magnetic field with a different or varying frequency according to the type of measured quantity or position. The universal excitation generator as well as the excitation element will optionally be adapted to this, or various excitation elements will be used for various applications. Thank to this finding, one construction of the bistable magnetic wire can also be used at different frequencies. The stable frequency value for one application may differ from the stable frequency used in another application, or these frequencies may be variable in a range different for the particular type of measurement.

A significant advantage of the present invention is the repeatable accuracy of the measurements, which is related to the increase of the interpretation level of the obtained raw data. A rapid response to a change in the measured physical quantity was also demonstrated. Thanks to the small dimensions of the bistable magnetic wire, the low cost and its energetic passivity, the system according to this invention can be used in a wide range of technical applications.

### DESCRIPTION OF FIGURES

The invention is explained in more detail using FIGS. 1 to 10. The particular sizes of the wire, the excitation element shown and also the values of measured quantities shown are only examples, which should not be explained as a narrowing of the required protection of the invention.

FIG. 1 is a block schematic representation of the structure of the bistable magnetic wire.

FIG. 2 represents the results of bending stress measurement on a steel bracket, where on the left are the results of measurements with a classically bistable magnetic wire from the prior art and on the right are the results of measurements with the bistable magnetic wire according to the invention. FIG. 2 clarifies the solved technical problem, which occurs in prior art solutions.

FIG. 3 schematically shows the positional asymmetry of the excitation element to the bistable magnetic wire.

FIG. 4 schematically explains the asymmetrically wound coil of excitation element.

FIG. 5 shows system for tension measurement in a test tear sample.

FIG. 6 schematically shows the system for measuring the temperature on the surface of a battery cell. Subsequently, FIG. 7 shows the dependence of the temperature course on the sum of times T1+T2.

FIG. 8 shows an oscilloscope screen with peak time values aT1-T2 to cT1-cT2 when measuring temperature with three bistable magnetic wires.

FIG. 9 shows the coaxial position of the bistable magnetic wire with respect to the excitation element and the sensing element when measuring the linear position of the piston.

FIG. 10 shows the magnetization of the bistable magnetic wire between two states when excited by a triangular signal.

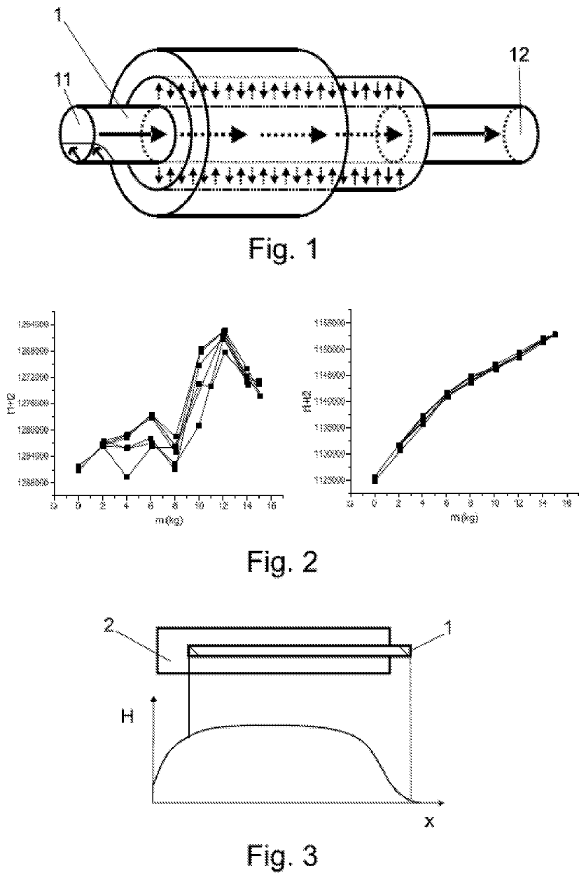

### EXAMPLES OF EMBODIMENTS

### Example 1

In this example according to FIGS. 3 and 5, the bistable magnetic wire 1 is used for measurement the tension, or the pressure in the steel part. The tear pattern has a calibrated center zone and two clamping ends. A micro wire with a metal core diameter of approx. 15 μm and with glass cover with a total diameter of approx. 45 μm with a length of approximately 3 cm are glued to the surface in the central zone. In this example, the bistable magnetic wire 1 is oriented in the direction of the tension force, wherein the elongations of the steel material are transmitted to the deformation of the bistable magnetic wire 1. Slight mounting angular position deviations do not have a significant effect on the measurement accuracy. The bistable magnetic wire 1 is at the same time essentially aligned in a straight line, where the first end 11 and the second end 12 are in a mutual opposite position, so that the bistable magnetic wire 1 is not wound on the core, as known from prior art applications.

An important feature of this example is the creation of the asymmetry of the excitated magnetic field using positional asymmetry. The excitation element 2 is placed next to the bistable magnetic wire 1, the longitudinal axis of the excitation element 2 is essentially parallel to the longitudinal axis of the bistable magnetic wire 1, wherein the center of the coil of the excitation element 2 is moved with respect to the center of the bistable magnetic wire 1 by the value X recorded in FIG. 6. In order to ensure a small distance between the excitation element 2 and the bistable magnetic wire 1, the longitudinal axis of the excitation element 2 and the longitudinal axis of the bistable magnetic wire 1 are placed in a position, where if we intersect one common plain through them, this common plain is essentially perpendicular to the surface of the steel part. However, in principle the measuring system is insensitive to the inaccuracies of the placement of the individual elements, it is only essential, that the elongations of the measured material are reliably transferred to the bistable magnetic wire 1.

The positional asymmetry of the excitation element 2 leads to the desired difference of the magnetic field at the first end 11 and at the second end 12, which together with the properties of the bistable magnetic wire 1 leads to magnetization by a single Barkhausen jump from the first end 11 to the second end 12. The excitation element 2 generates a magnetic field with a triangular signal and the response of the bistable magnetic wire 1 is captured with a sensor element 3, which is connected to the control unit 4, where the response is evaluated.

Static and dynamic measurement take place on a tear machine. The signal obtained in the sensing element 3 is overall monotonic and with a high repeated accuracy.

### Example 2

For measurement the temperature of the cylinder battery cell according to FIGS. 6 and 7 a heat-sensitive bistable magnetic wire 1 is placed on the cell surface. The system also comprises a planar coil of the excitation element 2 and a smaller coil of the sensing element 3. The measurement was performed in the temperature range from −20 to +100° C.

The analog signal from the bistable magnetic wire 2 in the form of two peaks (minimum and maximum) is monitored by an oscilloscope. The position time of the signal peaks T1 (maximum) and T2 (minimum) is processed and transformed into a digital signal in the control unit 4 and is subsequently displayed on the PC. The measured and evaluated signal shows an almost linear dependence between the temperature and the magnetic response of the bistable magnetic wire 1, which is defined by the sum of the values T1+T2. Subsequently, the parameters from the detected dependence were used to adjustment the parameters of the software that shows the actual temperature. In the case of a monotonic dependence, a calibration polynomial can be defined to be used to assign the raw data to the actual temperature. The sampling frequency is 2 samples/second with a sensitivity of 0.4° C. (K), which corresponds to a 288-point change at 120° C. interval.

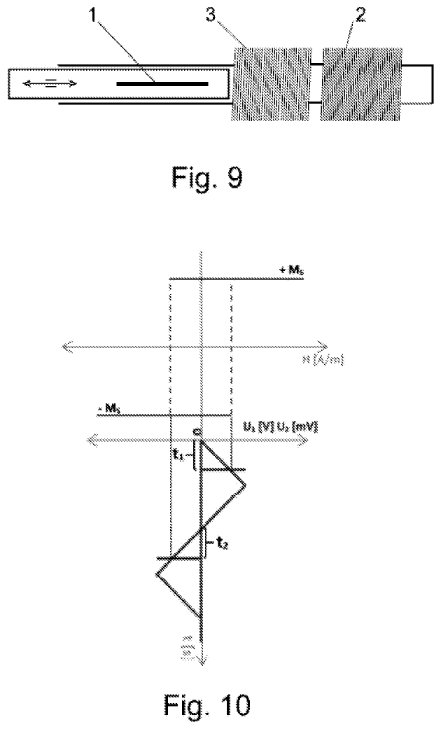

With one excitation element 2 and with one sensing element 3 it is possible to create a system for measuring the temperature of several battery cells. As can be seen in FIG. 9, it is possible to clearly distinguish the time positions of the signal peaks for the three bistable magnetic wires 1, which are individually placed on the three cylindrical battery cells. The peaks are marked as aT1-aT2 to cT1-cT2. The signal received in this way can be clearly detected, decomposed and transformed into the temperature of the individual battery cells.

### Example 3

One bistable magnetic wire 1, which is connected to a moving piston, is used for measurement the linear position with high accuracy. The bistable magnetic wire 1 in this example with the composition Fe_{77.5}Si_{7.5}B₁₅ has a positive magnetostriction, has a length of 30 mm, a metal core diameter of 39 μm and a diameter with the glass layer of 71 μm.

In this example according to FIG. 9, the excitation element 2 and the sensing element 3 are formed by coils, which loosely surround the sliding piston. The longitudinal axes of the excitation element 2, the sensing element 3 and the piston are identical. The bistable magnetic wire 1 is mounted on the surface of the piston, so it has only an approximately coaxial position with the excitation element 2 and the sensing element 3, which, however, does not affect the accuracy of the position measurement.

The asymmetry of the magnetic field in this example is achieved by positional asymmetry, wherein in each position of the piston the center of the bistable magnetic wire 1 is placed outside of the center of the excitation element 2. Moreover, in this example applies, that also both ends 11, 12 are in each position placed outside of the center of the excitation element 2. The position of the excitation element 2 is thus set so that at the end position of the piston, one end of the bistable magnetic wire 1 extends inside the coil of the excitation element 2, but does not reach the center of the excitation element 2. Subsequently, the piston with the bistable magnetic wire 1 extends even more from the inside of the coil of the excitation element 2.

Unlike conventional position sensors, where the position is defined by the magnetic permeability and amplitude of the signal on the sensing coil, the system according to this example detects the magnetization proportional to the position of the bistable magnetic wire 1.

A reliable induction method is used for detection of magnetization. The excitation field has a triangular shape and the switching time is measured, where T1 and T2 express the magnetization time (positive and negative switching) between the two stable magnetic states according to FIG. 10. The switching time corresponds to the time when the maximum voltage is induced. The maximum and minimum of the received signal can be clearly identified, the background does not affect the interpretation possibilities. The correctly amplified and filtered sensed signal is connected to the digital input of a single-chip computer with a time resolution of within 10 ns. The simple electronics in the control unit 4 is sufficient to achieve very high accuracy and measurement speed. The digital unit of the microcontroller generates a PWM signal of the desired frequency, in this example 135 Hz. After filtering the received signal and transforming it, the times T1+T2 are sum up by a timer.

The advantage of the system according to this example is the sharp maximum of the signal induced during the magnetization and the high sensitivity at the level of 10 μm. The system is also independent of the ambient temperature, the measurement error due to temperature sensitivity is less than 0.19%.

### Example 4

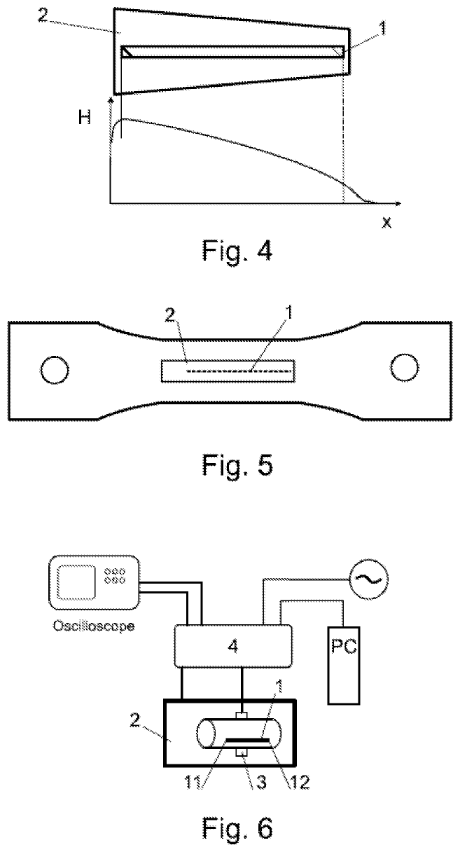

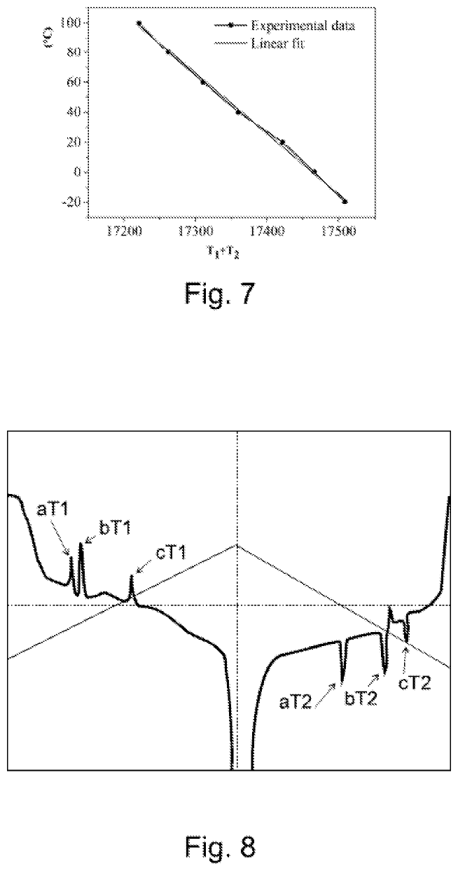

In this example according to FIG. 4, the coil of the excitation element 2 is wound unevenly so that it has an increased number of threads at one end. At the same time, the bistable magnetic wire 1 is positioned so that at a given time of non-zero excitation, the size of the magnetic field excited by the excitation element 2 at the first end 11 is at least 5% different from the size of the magnetic field excited by the excitation element 2 on the second end 12.

### INDUSTRIAL APPLICABILITY

The industrial applicability is obvious. According to this invention, it is possible to industrially and repeatedly manufacture and use the spatial and constructional arrangement of the excitation element and the bistable magnetic wire for measurement a physical quantity and/or for measuring a position, in particular for measurement of temperature, pressure, tension, magnetic field, electric current, position, earth's magnetic field, torsion, linear or angular position.

### LIST OF REFERENCE MARKS

1—bistable magnetic wire
   11—first end
   12—second end
2—excitation element
3—sensing element
4—control unit
T1—maximum signal response time
T2—minimum signal response time

1. A system for physical quantity measurement and/or for position measurement with a bistable magnetic wire (1), which comprises the bistable magnetic wire (1) an excitation element (2) adapted for creating a magnetic field in a range where the bistable magnetic wire (1) is placed, which has a first end (11) and an oppositely placed second end (12), wherein the bistable magnetic wire (1) is adjusted for magnetization by a single Barkhausen jump from the first end (11) to the second end (12) or vice versa, and which also comprises a sensing element (3) for response receiving from the bistable magnetic wire (1), wherein
the excitation element (2) and the bistable magnetic wire (1) are placed in a position such that the amplitude of the magnetic field excited by the excitation element (2) at the first end (11) is different from the amplitude of the magnetic field excited by the excitation element (2) at the second end (12).

2. The system for physical quantity measurement and/or for position measurement with the bistable magnetic wire according to claim 1, characterized in that, the difference in amplitude of the magnetic field at the first end (11) and at the second end (12) is at least 5%, preferably at least 10%.

3. The system for physical quantity measurement and/or for position measurement with the bistable magnetic wire according to claim 1, characterized in that it is adapted to measure temperature and/or pressure and/or tension and/or magnetic field and/or linear position.

4. The system for physical quantity measurement and/or for position measurement with the bistable magnetic wire according to claim 1, characterized in that the coil of the receiving element (3) is separate from the coil of the excitation element (2).

5. The system for physical quantity measurement and/or for position measurement with the bistable magnetic wire according to claim 1, characterized in that the bistable magnetic wire (1) has a diameter less than 50 μm.

6. The system for physical quantity measurement and/or for position measurement with the bistable magnetic wire according to claim 1, characterized in that the bistable magnetic wire (1) is covered with a layer of insulating material, preferably with a layer of glass.

7. The system for physical quantity measurement and/or for position measurement with the bistable magnetic wire according to claim 6, characterized in that the glass has a thickness up to 20 μm.

8. The system for physical quantity measurement and/or for position measurement with the bistable magnetic wire according to claim 1, characterized in that the length of the bistable magnetic wire (1) is at least 1,000 times, preferably at least 10,000 times greater than the diameter of the metal core of the bistable magnetic wire (1).

9. The system for physical quantity measurement and/or for position measurement with the bistable magnetic wire according to claim 1, characterized in that the excitation element (2) is placed asymmetrically to the position of the bistable magnetic wire (1).

10. The system for physical quantity measurement and/or for position measurement with the bistable magnetic wire according to claim 1, characterized in that the excitation element (2) has an asymmetrical structure with different amplitude of magnetic fields at its ends.

11. The system for physical quantity measurement and/or for position measurement with the bistable magnetic wire according to claim 10, characterized in that the excitation element (2) is formed by a coil with a different winding density at the first end (11) and the second end (12).

12. The system for physical quantity measurement and/or for position measurement with the bistable magnetic wire according to claim 1, characterized in that the longitudinal axis of the excitation element (2) is identical or parallel with the longitudinal axis of the bistable magnetic wire (1), or the longitudinal axis of the excitation element (2) deviates from the longitudinal axis of the bistable magnetic wire (1) within 30 degrees.

13. A method for physical quantity measurement and/or for position measurement with a bistable magnetic wire, wherein a variable magnetic field is transmitted by an excitation element (2), wherein at least one bistable magnetic wire (1) is placed within the range of the excited magnetic field, which is magnetized when the magnetic field changes by a single Barkhausen jump from the first end (11) to the second end (12) of the bistable magnetic wire or vice versa and where the response of the bistable magnetic wire (1) is subsequently sensed by a sensing element (3), wherein the excitation element (2) and the bistable magnetic wire (1) are maintained in a position such that the amplitude of the magnetic field excited by the excitation element (2) at the first end (11) is different from the amplitude of the magnetic field excited by the excitation element (2) at the second end (12).

14. The method for physical quantity measurement and/or for position measurement with the bistable magnetic wire according to claim 13, characterized in that the excitation magnetic field has a triangle-shaped amplitude waveform, preferably a symmetrical triangle-shaped, and the time (T1) of the local maximum and the time (T2) of the local minimum of response of the bistable magnetic wire (1) are evaluated.

15. The method for physical quantity measurement and/or for position measurement with the bistable magnetic wire according to claim 13, characterized in that the excitation magnetic field has a frequency in a range in which the bistable magnetic wire (1) has at least one local maximum of sensitivity for a particular type of measured quantity or position.

16. The method for physical quantity measurement and/or for position measurement with the bistable magnetic wire according to claim 14, characterized in that when evaluating the signal received as a response from the bistable magnetic wire (1), the sum of the time (T1) of local maximum and time (T2) of local minimum of signal are evaluated, preferably without taking into account the absolute amplitude of the signal.

17. The method for physical quantity measurement and/or for position measurement with the bistable magnetic wire according to claim 16, characterized in that when evaluating the signal received as response from the bistable magnetic wire (1), the difference of the time (T2) of the local minimum and the time (T1) of the local maximum of the signal is taken into account.

18. The method for physical quantity measurement and/or for position measurement with the bistable magnetic wire according to claim 13, characterized in that the response of the bistable magnetic wire (1) intercepted in the sensing element (3) is evaluated in the control unit (4).
